(19) United States
(12) Patent Application Publication
(10) Pub. No.: US 2007/0015465 A1
(43) Pub. Date: Jan. 18, 2007

(54) System comprising controlled-supply bluetooth communication module, radio communication assembly, methods and readers

(76) Inventors: Olivier Giroud, Paris (FR); Thomas Serval, Neuilly Sur Seine (FR)

Correspondence Address: YOUNG & THOMPSON, 745 SOUTH 23RD STREET, 2ND FLOOR, ARLINGTON, VA, 22202, US

(21) Appl. No.: 10/545,444

(22) PCT Filed: Feb. 13, 2004
(86) PCT No.: PCT/FR04/50060

§ 371 Date: Aug. 3, 2006

(30) Foreign Application Priority Data
Feb. 14, 2003 (FR) 03.50027

(51) Int. Cl. H04B 7/00

(52) U.S. Cl. 455/41.2; 340/825.69; 340/10.1

(57) ABSTRACT

An equipment control system, with a stand-alone power supply source, contains a command reception and detection unit, the electromagnetic radio waves complying with a voice or data radio communication standard in a radio frequency band, the standard providing at least one function causing, the transmission of a data packet corresponding to a set temporal structure pattern containing transmission moments of a frequency and/or phase modulated radio-frequency signal separated by absence-of-transmission moments. The invention, the set temporal structure pattern is transmitted by an electromagnetic generator and the reception and detection unit is a reception circuit, in the determined radio frequency band, and a detector for an amplitude modulation with a detection output, the detector not being sensitive to the frequency and/or phase modulation, the level of the detection output toggling when the set temporal structure pattern is received and detected.

The invention concerns notably a system comprising a controlled-supply Bluetooth® communication module as well as a radio communication assembly, corresponding operating and implementation methods as well as electronic tag readers. It is notably intended to provide Bluetooth® functionality to stand-alone equipment from the viewpoint of electric power supply and over a long period. It may notably be applied in stand-alone recorders and wireless sensors.

Stand-alone measuring equipments are known, intended to record over long periods of time, months or years, certain parameters measured regularly and notably environmental parameters such as temperature, shock or others. The measurements recorded are then transferred into a computer system where they may be processed. These pieces of equipment are notably employed to ensure traceability and follow-up of matters whereof the preservation may depend on the environmental conditions. In particular, and for exemplification purposes, a DS1615 integrated circuit manufactured by MAXIM®/DALLAS® is known, which includes memory, an electronic thermometer and a clock and which enables to perform temperature recordings regularly, then to transfer it over a wire link to an external computer device. The power consumption of this circuit is very low thanks to the usage of CMOS-type components and to low clock frequency, a few kilohertz.

Other pieces of measuring equipment implement radio transfer means. However, the latter pieces of equipment may not benefit from the endurance and/or the reduced size of the former since their power consumption is much greater, the equipment, to be reactive, should be in permanent reception to be ready to transfer the data upon each request.

On the other hand, the patent application no FR01/04659 or its extension PCT/FR02/01202 in the name of the present applicant, divulges a Bluetooth® radio module with extended software capabilities. Said module exhibits reduced power consumption by implementing power cuts, which wake up the communication circuits or others regularly, specific of a given task at a given time. However, even with these means, the power consumption of the module is too great to expect sufficient endurance in a smaller-sized stand-alone piece of equipment.

Finally, the document no DE 100 44 035 divulges a system for mobile communication containing a radio frequency identification tag (RFID tag) enabling to re-activate an associated means of communication and the document no EP 1 134 905 divulges a mains device whereof the operation is controlled remotely with a capability for receiving a remote control signal which is different when in operation or not.

The purpose of the present invention is notably to be able to incorporate Bluetooth® functionality to a stand-alone power supply-integrated piece of equipment and which operates with an endurance ranging from several months to several years while being of reduced size, i.e. not requiring a voluminous power supply. Or simply adding a Bluetooth® module to a piece of equipment does not enable to reach these objectives since the module in listening mode has a power consumption of several mAs and a power supply source with a capacity of several tens of ampere-hours would be required, assuming that the piece of equipment itself has negligible electric power consumption, to have barely sufficient endurance. Such a power supply source, in addition to its own cost, exhibits relatively high volume which counteracts any miniaturisation of the equipment, whereas the electronic circuits properly speaking may be downsized considerably.

It is hence notably suggested to control the power supply of the Bluetooth® module relative to the reception and detection by an independent reception and detection unit of electromagnetic waves which are transmitted by an external electromagnetic generator. The Bluetooth® functionality is provided by a Bluetooth® radio module, preferably of the extended software capability type similar to that of the patent applications aforementioned. The unit includes a receiver and a detector with reduced power consumption relative to the radio means of the module and is permanently in reception mode. The typical power consumption of the unit is of the order of a few tens microamperes, possibly less or zero relative to the degree of sophistication of said unit. The unit is preferably of the electronic radio tag type which detects the generator only at short distance. The module in the system being usually not power supplied, the unit permanently in listening mode having very low power consumption and the controlled circuit for switching the power supply of said module being essentially static, the power consumption of the system is extremely reduced. Adding the system to a piece of stand-alone measuring equipment reduces hence the endurance thereof only marginally. It should be understood that the module includes at least one input, possibly at least one output, to be connected to the equipment to which one wishes to add Bluetooth® functionality. The system being permanently in listening mode by dint of the reception and detection unit, the reactivity of the system is practically instant for the user, the initialisation time of the Bluetooth® module being relatively short, of the order of a few ten to hundred milliseconds. The invention may be implemented with any type of generator adapted to the unit and it will be appreciated that it is even possible to use Bluetooth® radio signals to activate the system, the unit receiving and detecting said signals, which dispenses with using a specific generator.

The invention uses available functionalities of radio-transmission equipment according to standards to be able to activate a piece of equipment, which may notably be a Bluetooth® module, by dint of a simplified reception and detection unit, and with low power consumption with respect to what a receiver, a detector (and the downstream circuits necessary) operating according to the standard usually are. The reception and detection unit is intended for receiving and detecting signals radio of a few functions (in practice one) from radio-transmission equipment according to a standard, the unit relating only to the variations in amplitude with time, of the radio signals over the whole frequency band of the standard and without being able to decode the function if the latter involves decoding according to the standard.

The invention concerns hence a system for controlling a piece of equipment by electromagnetic radio waves, the system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments.

According to the invention, the set temporal structure pattern is transmitted by an electromagnetic generator according to the standard and external to the system and the reception and detection unit is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected.

In various embodiments of the invention, the following means which may be used individually or according to all the technically possible combinations are employed:
the standard is selected among the BLUETOOTH®, Wi-Fi® or GSM/GPRS® protocols and, in the case of the BLUETOOTH® standard, the radio frequency band is the 2.4 GHz to 2.48 GHz ISM band, the function is an identification function and the data packet is an identity packet pattern (ID_packet), and in the case of the standard GSM/GPRS®, the function is a handshake function and the data packet is a channel random access packet pattern (<<random access channel>> or RACH),
in the case of the standard Wi-Fi®, the function is an identification and/or handshake function according to the functions available,
the equipment is an electric appliance, notably a lighting lamp, a mechanism-driving motor . . .
the equipment is an electronic apparatus and notably a piece of measuring equipment such as a recorder and/or a wireless sensor,
the equipment is an electronic transceiver according to the standard,
the detection output of the reception and detection unit is connected to an encoding device enabling to determine output states relative to a repetition according to determined temporal modalities of toggling sequences of the detection output of the unit, (one hence conducts repetitively the function according to a set temporal pattern, causing in the transmitter according to the standard, the transmission of a data packet corresponding to a set temporal structure pattern so that the detection output exhibits such a set temporal pattern which may be recognised by the decoding device, the set temporal pattern may correspond to alphanumeric signs, instructions, data . . . which enables notably data transmission)
the decoding device is integrated to the equipment,
the decoding device is separate from the equipment and from the reception and detection unit,
the decoding device is integrated to the reception and detection unit,
the system is intended for switching the electric power supply of the equipment and that the detection output of the reception and detection unit is connected to a command input of a controlled circuit for switching the power supply of the equipment so that when the detection output toggles, the equipment is power supplied,
the power supply-controlled switching circuit includes at least one passive device for power supply switching,
the passive device is an electromagnetic relay,
the power supply-controlled switching circuit includes at least one active device for power supply switching,
the switching control circuit includes moreover voltage regulation means,
the active device is a power transistor,
the power supply-controlled switching circuit includes at least one MOS power transistor with control gate for power supply switching,
the equipment is a Bluetooth® communication module containing a stand-alone power supply source, the communication module being power supply-controlled, the reception and detection unit of electromagnetic waves complies with the amplitude modulation (ASK) for detecting an identity packet (ID_Packet) of DAC or IAC type transmitted by the external electromagnetic generator according to the BLUETOOTH® standard, the detection output of the reception and detection unit being connected to the command input of the power supply-controlled switching circuit so that, when the electromagnetic radio wave of the identification packet transmission function (ID_packet) is received and detected by the unit, the Bluetooth® communication module is powered by the stand-alone power supply source,
the reception and detection unit is a passive electronic tag, the power supply of the tag being provided by the electromagnetic generator, the electromagnetic waves of the electromagnetic generator being used for the power supply of the tag,
the reception and detection unit is an active electronic tag, the power supply of the tag being provided by a stand-alone power supply source of the equipment,
the active electronic tag includes a periodic activation means enabling the reception and detection unit to operate according to repetitious periodic de-activation of a duration T1 followed by a listening mode of a duration T0 in order to reduce the power consumption thereof,
the periodic activation means enables moreover that the reception of a transmission of a radio-frequency signal in the frequency band causes for a determined duration, the reduction of the de-activation duration or the disappearance of the de-activation,
T1>T0,
the possible minimum values of the times T1 and T0 are determined relative to the set temporal structure pattern,
the times T1 and/or T0 are constant,
the times T1 and/or T0 have random durations,
the set time for reducing the de-activation duration or the disappearance of the de-activation is greater than or equal to the sum of the times between two successive transmissions of set temporal structure pattern and of the duration of a set temporal structure pattern,
the power supply-controlled switching circuit includes moreover a time-delay means operatable by the command input and enabling to keep for a predetermined holding time the power supply of said equipment upon completed detection of the electromagnetic wave, the power supply of the equipment being switched off upon expiry of the predetermined holding time regardless whether there have been new detections or not during said holding time,
the power supply-controlled switching circuit includes moreover a time-delay means operatable by the command input and enabling to keep for a predetermined initial holding time the power supply of said equipment upon completed detection of the electromagnetic wave, the power supply of the equipment being switched off upon expiry of the predetermined holding time failing any new detection during said holding time, the detection of the electromagnetic wave during the holding sequence extending the holding sequence during the detection and the holding sequence during the predetermined holding time at the expiry of the detection,
the equipment includes a power supply control output connected to a second command input of the power supply switching-controlled circuit, the equipment being thus capable of controlling directly its power supply once power-supplied further to the detection of electromagnetic waves,
the system includes a watchdog for monitoring the power supply, the power supply-controlled switching circuit containing the time-delay means operatable by the command input with detection of the electromagnetic wave during the holding time extending the holding sequence for a new predetermined holding time, the time-delay means is moreover operatable by the second command input of the power supply switching-controlled circuit, said second input being active on a transition, whereby the equipment should regularly send said transitions via its power supply control output in order to maintain the power supply thereof,
the time-delay means operatable is replaced with a flip-flop logic with at least one R/S function and with:
   a set input (S),
   an reset input (R),
      the set input being connected to the output of the detector and the reset input being connected to a power supply control output.

The invention also relates to, an operating method of a system comprising a module controlling a piece of equipment by electromagnetic radio waves, the system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments.

According to the method, with a system possessing one or several of the previous characteristics, the set temporal structure pattern is transmitted via an electromagnetic generator according to the standard and external to the system and a command reception and detection unit is implemented which is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected.

The method of the invention may be applied according to all the possible operational modalities in relation to one or several of the hardware means listed previously of the system, and, notably in a variation of the method, a piece of equipment is implemented which is a Bluetooth® communication module with stand-alone power supply source, and that the power supply of the module is controlled relative to the reception and detection of electromagnetic waves transmitted by the electromagnetic generator according to the BLUETOOTH® standard with a controlled circuit for switching the power supply of said communication module containing a command input, the detection output having been connected to the command input of the power supply-controlled switching circuit so that when the detection output toggles, the Bluetooth® communication module is power supplied, the external generator operating in the 2.4 GHz to 2.48 GHz ISM radio frequency band with a function which is an identification function and a data packet which is an identity packet pattern (ID_packet).

The invention also relates to a radio communication assembly containing at least one system for controlling a piece of equipment by electromagnetic radio waves and at least one electromagnetic generator physically independent of the system, the system containing a command reception and detection unit independent of the equipment, the electromagnetic radio waves complying with a voice or data radio communication standard in a determined radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments, wherein the assembly includes a system according to one or several of the features listed previously, the command reception and detection unit being a reception circuit, in the determined radio frequency band, and being a detector for an amplitude modulation (ASK) with a detection output, the detector not being sensitive to the frequency and/or phase modulation, the level of the detection output toggling when the set temporal structure pattern is received and detected, and in that the temporal structure pattern is transmitted by an electromagnetic generator according to the standard.

In various embodiments of the assembly:
the reception and detection unit of electromagnetic waves is an electronic tag and the generator is an electronic tag reader,
the equipment is a Bluetooth® communication module containing a stand-alone power supply source, the communication module being power supply-controlled, the system being intended for switching the electric power supply of the communication module and the detection output of the tag being connected to a command input of a controlled circuit for switching the power supply of the communication module so that when the detection output toggles, the communication module is power supplied, and in that the electronic tag reader includes moreover a Bluetooth® radio communication device capable of making it communicate with a base station and the module of the system,
the equipment is a Bluetooth® communication module containing a stand-alone power supply source, the communication module being power supply-controlled, the system being intended for switching the electric power supply of the communication module and the detection output of the tag being connected to a command input of a controlled circuit for switching the power supply of the communication module so that when the detection output toggles, the communication module is power supplied, and in that the electromagnetic generator of the electronic tag reader operates in the 2.4 GHz to 2.48 GHz ISM radio frequency band with a function which is an identification function and a data packet which is an identity packet pattern (ID_packet).

The invention also relates to an implementation method of the preceding radio communication assembly wherein in:
a first step, the electronic tag reader is activated in order to generate electromagnetic waves enabling the command reception and detection unit to operate the power supply of the Bluetooth® module and to feed (power) said module,
a second step, at least one data exchange is conducted between the Bluetooth® module and the Bluetooth® radio communication device of the electronic tag reader,
a third step, the Bluetooth® module controls the switching-off of its own power supply.

The invention finally concerns a first electronic tag reader for generating electromagnetic radio waves intended to operate a system containing a command reception and detection unit independent of the equipment, the electromagnetic radio waves complying with a voice or data radio communication standard in a determined radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments, wherein the system complies with one or several of the corresponding features listed previously of the system, where the reception and detection unit is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected, said reception and detection unit being an electronic tag and the set temporal structure pattern being transmitted by the electromagnetic generator of the tag reader according to the standard, the tag reader containing moreover a Bluetooth® radio communication device which may cause the reader to communicate with a base station and the module of the system.

The invention finally concerns a second electronic tag reader for generating electromagnetic radio waves intended to operate a system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments, wherein the system complies with one or several of the corresponding features listed previously of the system, where the command reception and detection unit is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected, and the reception and detection unit is an electronic tag intended for receiving and detecting electromagnetic waves according to the BLUETOOTH® standard, and the electronic tag reader includes an electromagnetic generator which is a radio communication device transmitting according to the BLUETOOTH® standard, the radio frequency band being the 2.4 GHz to 2.48 GHz ISM band, the function being an identification function and the data packet being an identity packet pattern (ID_packet).

According to another presentation modality of the invention which concerns more particularly an application with a Bluetooth® communication module, the invention relates to a system with Bluetooth® communication module containing at least:
a stand-alone power supply source,
the Bluetooth® communication module.

According to the invention with this other modality, the module is power supply-controlled, the system containing moreover:
a controlled circuit for switching the power supply of said communication module with a command input,
a reception and detection unit of electromagnetic waves transmitted by an external electromagnetic generator, the unit being independent of the module and containing a detection output,
   the detection output being connected to the command input of the power supply-controlled switching circuit so that when the electromagnetic wave is detected by the unit, the Bluetooth® communication module is power supplied.

In various embodiments of the invention presented according to this other modality, the following means which may be used individually or according to all the technically possible combinations, are employed (these means may also be employed in the invention in its entirety as presented previously):
the power supply-controlled switching circuit includes at least one passive device for power supply switching,
the passive device is an electromagnetic relay,
the power supply-controlled switching circuit includes at least one active device for power supply switching,
the switching control circuit includes moreover voltage regulation means,
the active device is a power transistor,
the power supply-controlled switching circuit includes at least one MOS power transistor with a control gate for power supply switching,
the reception and detection unit of electromagnetic waves detects in a specific reception range any wave whereof the level of the electromagnetic field is greater than a predetermined level,
   (the word specific corresponds to a reception band according to a particular standard)
the reception and detection unit of electromagnetic waves includes moreover a means for detecting a particular electromagnetic wave,
the particular electromagnetic wave is a wave according to the BLUETOOTH® standard,
the reception and detection unit of electromagnetic waves includes moreover a means for detecting a particular electromagnetic wave, the particular electromagnetic wave being a wave according to the BLUETOOTH® standard and all or nothing modulation by identity packet (ID_Packet) of DAC or IAC type,
the means for detecting the particular electromagnetic wave with all or nothing modulation by identity packet (ID_Packet) of DAC or IAC type according to the BLUETOOTH® standard includes a modulation counter and a time-delayed resetting circuit of the counter whereof the delay is reset by a modulation, so that the detection output toggles only upon reception of a predetermined number of all or nothing modulations of identity packet (ID_Packet), each separate from the next by a time smaller than the delay,
the reception and detection unit is of the electronic radio tag (<<TAG>>) with detection output,
the electronic tag is passive, the power supply of the unit being provided by the external electromagnetic generator, the electromagnetic waves of the generator being used for the power supply of the tag,
the electronic tag is active, the power supply of the unit being provided by the power supply source,
the power supply-controlled switching circuit includes moreover a time-delay means operatable by the command input and enabling to keep for a predetermined holding time the power supply of said module upon completed detection of the electromagnetic wave, the power supply of the module being switched off upon expiry of the predetermined holding time regardless whether there have been new detections or not during said holding time,
the power supply-controlled switching circuit includes moreover a time-delay means operatable by the command input and enabling to keep for a predetermined initial holding time the power supply of said module upon completed detection of the electromagnetic wave, the power supply of the module being switched off upon expiry of the predetermined holding time failing any new detection during said holding time, the detection of the electromagnetic wave during the holding sequence extending the holding sequence during the detection and the holding sequence during the predetermined holding time at the expiry of the detection,
the time-delay means is a capacitor arranged on the control gate of a MOS power transistor for switching (or regulating) the power supply,
the time-delay means is a time-delayed monostable circuit,
the new predetermined holding time is equal to the initial predetermined holding time.,
the new predetermined holding time is greater than the initial predetermined holding time,
the new predetermined holding time is lower than the initial predetermined holding time,
the module includes a power supply (or forced supply) control output connected to a second command input of the power supply switching-controlled circuit, the module being thus capable of controlling directly its power supply once power-supplied further to the detection of electromagnetic waves,
the power supply-controlled switching circuit includes a time-delay means operatable by the second command input,
the power supply-controlled switching circuit includes a single time-delay means operatable,
the system includes a watchdog for monitoring the power supply, the power supply-controlled switching circuit containing the time-delay means operatable by the command input with detection of the electromagnetic wave during the holding time extending the holding sequence for a new predetermined holding time, the time-delay means is moreover operatable by the second command input of the power-supply switching-controlled circuit, said second input being active on a transition, whereby the module should regularly send said transitions over its power supply control output in order to maintain the power supply thereof,
the time-delay means operatable is replaced with a flip-flop logic with at least one R/S function and with:
a set input (S),
an reset input (R),
   the set input being connected to the output of the detector and the reset input being connected to a power supply control output,
the power supply source is electrochemical of the battery type,
the module includes moreover a de-activation output intended to enable de-activation of the detection output of the unit,
the module is connected to at least one sensor,
the sensor is selected among the temperature, pressure, humidity, sound, brightness, vibration sensors,
the sensor includes a stand-alone recording means with memorisation of measurements in a memory, whereas the module may read said memory when it is power supplied,
the module is connected to an electrically (re)programmable memory,
the module includes an electric control output of an external electric device,
the module includes an electronic communication output with an external electronic device,
the control or communication output for external device is isolated by photo-coupler.

The invention according to this other modality stills concerns an operating method of a system with Bluetooth® communication module with stand-alone power supply source wherein the power supply of the module is operated and a system is implemented according to one or several of the previous claims with:
a controlled circuit for switching the power supply of said communication module with a command-input,
a reception and detection unit of electromagnetic waves transmitted by an external electromagnetic generator, the unit being independent of the module and containing a detection output,
   the detection output having been connected to the command input of the power supply-controlled switching circuit so that when the electromagnetic wave is detected, the Bluetooth® communication module is power supplied.

The method of the invention according to this other modality may be applied according to all the possible operational modalities in relation to one or several of the hardware means listed previously of the system according to this other modality.

The invention according to this other modality also relates to a radio communication assembly.

According to this portion of the invention in this other modality, the assembly include:
at least one system according to any or several of the previous characteristics and containing a stand-alone power supply source, a Bluetooth® communication module with power supply controlled by a power supply switching circuit controlled by a reception and detection unit of electromagnetic waves,
at least one electromagnetic generator physically independent of the system enabling to generate electromagnetic waves which may control the power supply of the module by dint of the reception and detection unit.

In various embodiments of the assembly of the invention according to this other modality:
the reception and detection unit of electromagnetic waves is an electronic tag and in that the generator is an electronic tag reader, and/or:
the electronic tag reader includes moreover a Bluetooth® radio communication device capable of making it communicate with a base station and the module of the system.

The invention according to this other modality also relates to an implementation method of the previous radio communication assembly according to the invention according to this other modality and wherein in:
a first step, the electronic tag reader is activated in order to generate electromagnetic waves enabling the command reception and detection unit to operate the power supply of the Bluetooth® module and to feed said module,
a second step, at least one data exchange is conducted between the Bluetooth® module and the Bluetooth® radio communication device of the electronic tag reader,
a third step, the Bluetooth® module controls the switching-off of its own power supply.

The invention according to this other modality also relates to an electronic tag reader for generating electromagnetic waves intended to operate a system according to any or several of the previous corresponding characteristics and containing a stand-alone power supply source, a Bluetooth® communication module with power supply controlled by a power supply switching circuit controlled by a reception and detection unit of electromagnetic waves, said unit being an electronic tag, said reader containing in addition to the generator a Bluetooth® radio communication device which may cause the reader to communicate with a base station and the module of the system.

The invention according to this other modality finally concerns an electronic tag reader for generating electromagnetic waves intended to operate a system according to any or several of the previous corresponding characteristics and containing a stand-alone power supply source, a Bluetooth® communication module with power supply controlled by a power supply switching circuit controlled by a reception and detection unit of electromagnetic waves, said unit being an electronic tag intended for receiving and detecting electromagnetic waves according to the Bluetooth® protocol, the generator of said reader being a Bluetooth® radio communication device which may cause the reader to communicate with a base station and the module of the system.

The invention, by adding a reception and detection unit of electromagnetic waves and a power supply-controlled communication circuit whereof the cost may be small and the reduced physical space requirements, enables to benefit from a Bluetooth® functionality in a long endurance equipment without needing to employ a voluminous and costly power supply source.

The advantage of an active tag type unit relative to the passive tags is the increased reach. All things being considered, the electric consumption of a radio tag remains vastly smaller than the power consumption of the Bluetooth® module in listening mode.

The present invention will now be exemplified without being limited thereto with the following description in relation to the following with Figures:

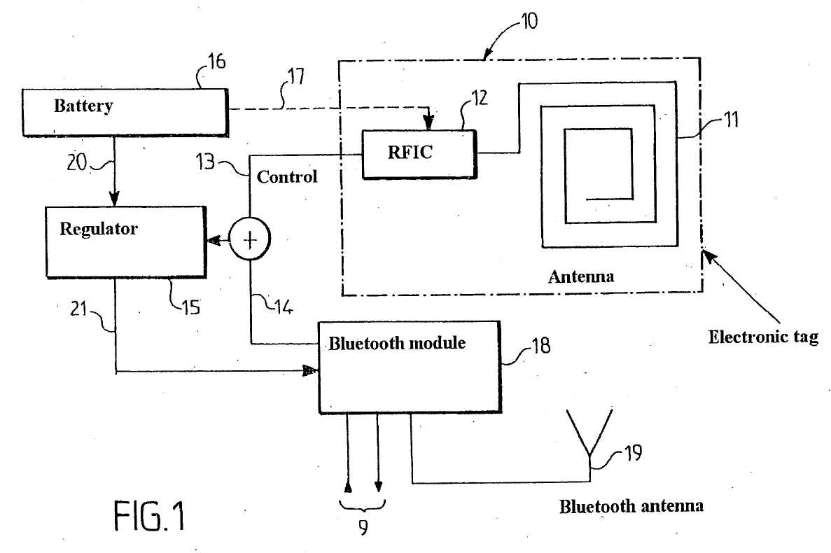

FIG. 1 which represents a system according to the invention,

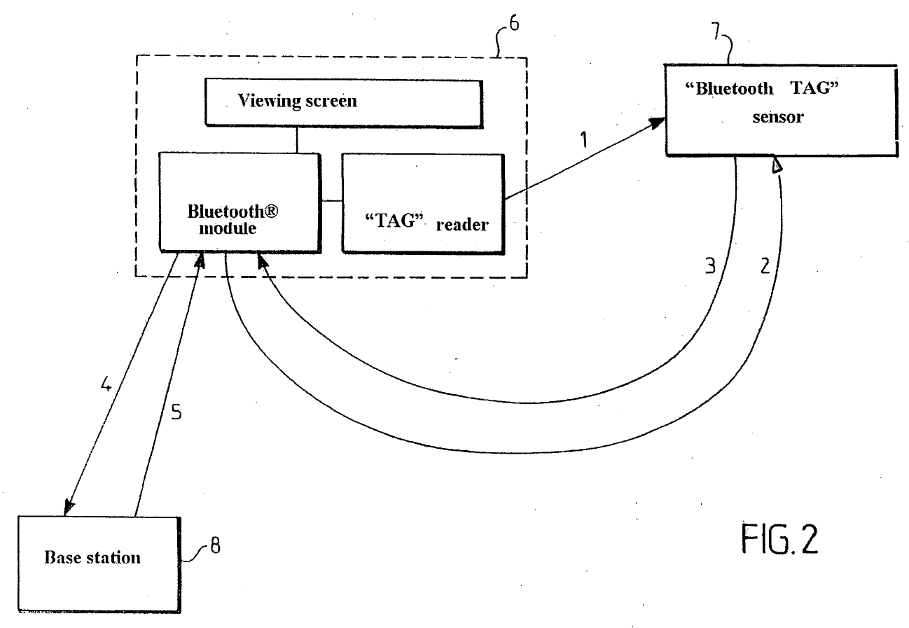

FIG. 2 which represents an operational diagram of an application implementing the system of the invention,

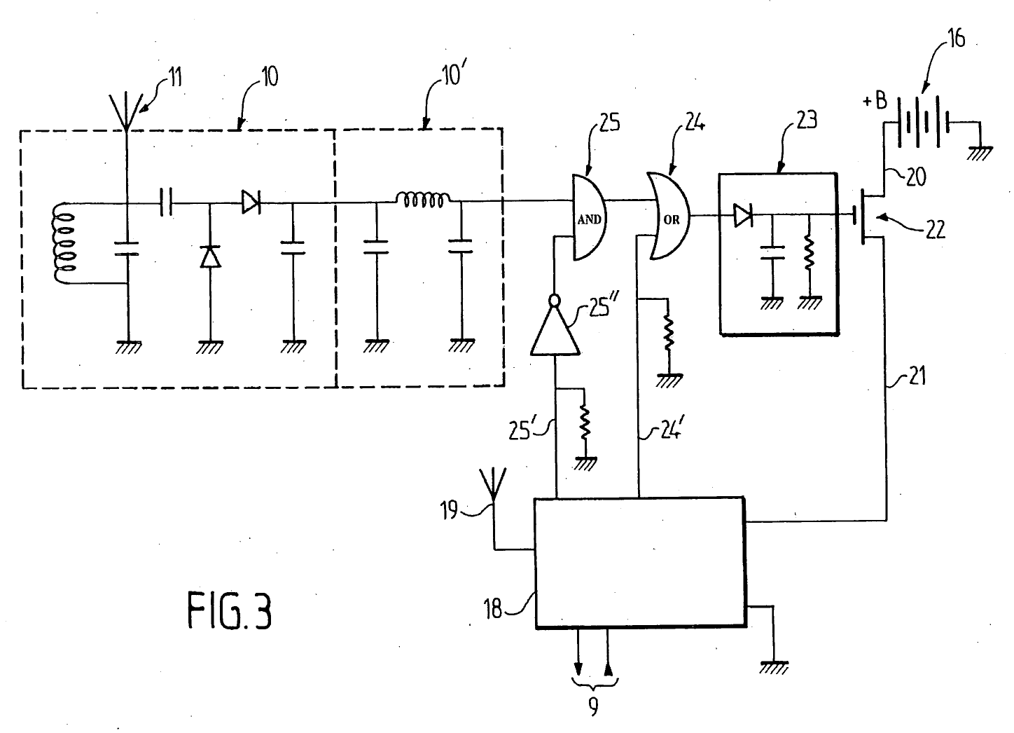

FIG. 3 which represents an example of electronic diagram of the system.

The system of FIG. 1 includes a reception and detection unit of electromagnetic waves which is an electronic radio tag 10 (<<TAG>>), an electric power supply source 16, a Bluetooth® module 18 and means enabling to switch the power supply of the Bluetooth® module 18. The electronic radio tag 10 includes an antenna 11 intended for capturing waves from an external generator not represented and a reception and detection circuit 12 containing an integrated circuit (<<RF IC>>) producing a control signal 13 over a detection output when the generator adapted to the tag is in operation. Conventionally, in the case of a tag, the integrated circuit of the tag performs the decoding, respectively the encoding, of the information received, respectively sent. The tag hence exchanges pieces of information with the external generator. The integrated circuit may record in a non-volatile reprogrammable memory (of EEPROM type) an identifier. This identifier is a chain of characters of a few bytes to a few kilo-bytes. The size of the information contained in the chip is limited by the memory capacity and by the radio transmission speed. A Bluetooth® module has no limitation of this type, it may store information of picture, video or sound recording type. In a simplified version, the tag is simply receiving. However, a tag with identifier enables to realise a specific activation of the module according to an identifier.

The power supply link 17 of the tag is shown in dotted lines since the latter may be passive, not requiring its own power supply, or, as represented, active, requiring its own power supply. The electronic tag includes hence an integrated circuit and an antenna. This antenna in the case of a passive tag plays a part, simultaneously of inductance enabling to generate a power supply induced current from an incident electromagnetic wave and of antenna enabling the reception of the radio signal. In the case of a so-called passive tag, the integrated circuit is fed (powered) by the induced current. This induced current is generally rather small and the energy available for the transmission of the tag is consequently reduced, which involves a reading reach reduced to a few centimetres, possibly more, relative to the frequency. The active electronic tag, for its own part, operates according to the same principles except that it includes a power supply source. This enables to increase its power and hence the reading distance. Nevertheless, we are still limited in flow rate and memory capacity as well as the reading distance compared to a Class 1 Bluetooth® version with a 100 mW transmission power.

One may also implement hybrid solutions wherein the tag includes a rechargeable battery. The battery may, for instance, be reloaded by induction, with the tag placed on a recharging generator for an extended time. It may also be recharged by solar batteries during the lighting periods of the solar battery tag. Although the charging current is small, the battery is recharged for an extended time and accumulates high energy which may be reproduced quasi-instantly when activating the tag, which may enable greater reach (active type operation). In such a hybrid model, an energy management system may switch the tag back to small reach mode operating only with the induced current (passive type operation) by the generator when the charge of the battery is insufficient so that the tag is always operatable regardless of the charge level of the battery.

The Bluetooth® module 18 is connected to an antenna 19 for exchanges according to the BLUETOOTH® standard and to a piece of equipment not represented by inputs and outputs 9, for instance a temperature or position sensor. The module 18 has moreover a power supply control output 14 which acts concurrently with the control signal 13 of the detection output of the tag, on means enabling to switch the power supply. The latter include essentially, in this example, a regulator 15 controlled by both outputs indicated previously, of the module and of the tag to render the regulator operational during detection to feed the module 18, to maintain the power supply or to switch off the power supply according to the orders of the module 18. The regulator is connected upstream to the battery by a link 20 fed permanently and downstream of the module by a link 21 fed or not, as requested.

On FIG. 2 the system of the invention is incorporated into a piece of stand-alone equipment 7, the <<Bluetooth TAG>> sensor, which includes a sensor, for instance a temperature sensor. An independent device 6 includes a generator, a <<TAG>> reader, intended to activate the module by detecting its signal by the electronic radio tag. The device 6 includes moreover a Bluetooth® module enabling radio exchanges notably with the equipment 7 containing the system of the invention and with a remote base station 8. User interfaces, notably a viewing screen, complete the device 6. The device 6 is notably what is called conventionally <<an electronic tag reader>> (simple reader or tag reader/programmer) as used for stock handling, but which includes moreover radio linking means according to the Bluetooth® protocol to enable remote exchanges (<<wireless>>) with a base station, conventionally a stock handling computer server. This device 6 may hence be used as well for simple reading or reading/programming conventional electronic tags and exchanges with the base station, as for the activation of the <<BluetoothTAG>> sensor of the invention and exchanges therewith by dint of the Bluetooth® link.

The usage script of this assembly of FIG. 2 is as follows. Initially, the Bluetooth® module of the <<Bluetooth TAG>> sensor 7 (the equipment) is switched off (the voltage regulator/control transistor acts as a blocking switch). An operator seeks to exchange pieces of information with the sensor 7 via a Bluetooth® link and it activates the generator, a <<TAG>> reader, of the device 6 in order, for instance, to write into a non-volatile memory of the electronic tag via a radio wave. This activation which causes detection by the tag and the power supply of the module of the equipment 7 corresponds to the reference 1. The Bluetooth® module of the equipment 7 is now fed and goes to listening mode. Data may then be exchanged between the device 6 of the operator and the Bluetooth® module of the equipment 7, which is referenced by 2 and 3. Once the data have been exchanged, the Bluetooth® module of the equipment 7 instructs the voltage regulator to toggle into blocking mode, which switches off the Bluetooth® module of the equipment 7. FIG. 2 represents finally the possibility of exchanging data by the references 4 and 5 between the device 6 and a base station 8. It should be understood that once fed, the module of the equipment 7 may also communicate with any other means of Bluetooth® radio communication of its environment and, for instance, directly with the base station. Henceforth, data exchanges between the <<Bluetooth TAG>> sensor and another piece of computer equipment may hence take place by dint of the device 6 then of the base station 8 itself connected to said equipment, either solely by dint of the base station 8 itself connected to said equipment, or directly on this other computer equipment if the latter is situated in the radio communication environment of the <<Bluetooth TAG>> sensor and posses Bluetooth® radio means.

In a first case, the reading device 6 possesses, as represented on FIG. 2, two transceivers, one for the <<TAG>> reader (its receiver may possibly be omitted) and one for the Bluetooth® module.

In a second case not represented, the reading device 6 possesses a single transceiver, the Bluetooth® module only, and this in case where the <<BluetoothTAG>> sensor may directly be activated and fed after reception by the reception unit of the Bluetooth® radio signal equipment 7.

The first case is that where the encoding used by the electronic tag is dissociated from the encoding used by the Bluetooth® protocol of the module of the <<Bluetooth®TAG>> sensor 7. In such a case, the tag portion of the equipment 7 may contain its own programming means.

The second case is that where the electronic tag of the equipment 7 uses the 2.4 GHz frequency which corresponds to the frequency of the BLUETOOTH® standard and, preferably, in such a case, the tag detects the signal or identity packet (ID_Packet) as defined in the version 1.1 (spec1.1) of the BLUETOOTH® standard, page 55, chapter <<4.4.1.1 ID Packet>>. This identification (ID_Packet) corresponds according to this standard to the Device Access Code (or DAC) or the Inquiry Access Code (or IAC) forming a data packet of a 68-bit length. This type of packet is used for seeking remote Bluetooth® peripherals. It is in, the form of an alternate 68 ms sequence or <<burst>> with a non-zero radio frequency amplitude on a 2.4 GHz carrier and followed by 244.5 ms without transmission. This transmission 68 ms <<burst>>, followed by 244.5 ms without transmission, forming a period of the identity packet, is repeated and corresponds to a temporal modulation.

It may be noted that although the BLUETOOTH® standard uses a frequency-hopping radio communication, the tag frequency selectivity is such that the frequency hops of the Bluetooth® transmission are not detectable by the tag and that it receives the whole Bluetooth® signal inside its reception band, the electronic tag <<sees>> a single 2.4 GHz carrier. In practice, the reception band of the tag is at least the width of the frequency band including the hops according to the BLUETOOTH® standard.

One meter away, with a Bluetooth® Class 2 transmitter (+4 dBm=2.5 mW approximately), the signal received at the tag is −50 dBm. To ensure detection and possible decoding of this temporal modulation (68 ms transmission, 244.5 ms without transmission) it is advisable to use a resonant antenna on the 2.4 GHz frequency with high overvoltage coefficient but, however, a selectivity enabling to receive the signal in spite of the frequency hops. There is moreover an amplification circuit of the signal in the tag. Preferably, the amplification circuit is switchable so as to activate it only periodically in order to reduce the average consumption of the system. Thus, for instance, the amplifier may operate for 1 s every 10 s, which enables to have satisfactory level of amplification, as an average, with significant reduction of the average consumption. The values indicated are purely illustrative.

The switching of the amplification circuit, in addition to all or nothing, may also influence the level of amplification in order to adapt the amplification to the environment (close or remote transmitter). Thus, it is contemplated to increase the amplification to enable connection from a further distance, only if necessary. Indeed, generally, the greater the amplification, the greater the consumption.

Moreover, it is also possible to make the holding sequence of the amplification (or the operation of the tag, more generally) for a set time, dependent on the presence or not of a modulation. It is thus possible to reduce the duration of amplification (or operation) to a minimum time corresponding to a period of the identity packet signal (68+244.5 ms) and in the presence of a modulation to preserve the amplification (or the operation) to enable the detection of a number of modulations exhibiting Bluetooth® identity packet characteristics.

The detection means of the identity packet (ID_Packet) in the tag may be a simple binary counter whereof the resetting is delayed (the time delay system of the resetting is reset by the reception of a signal) of a delay greater (in practice slightly greater) than the time between two successive <<bursts>>, i.e. greater than 244.5 ms, the counter thus permitting to count a number of modulations which ought to be repeated regularly with a given periodicity before an output toggles.

In the second case, a tag reader 6 using Bluetooth® may thus be employed as a radio interface towards a communication network with one or several pieces of computer equipment. The Bluetooth® interface of the reader 6 may then serve simultaneously as a connection protocol between the reader 6 and a base station 8 or a network, as well as a communication protocol between the reader 6 and a <<BluetoothTAG>> sensor 7.

The reception and detection unit of electromagnetic waves may be simplified to the extreme by being quasi passive and include downstream of a possible antenna, a frequency section CL circuit followed by a detector with a rectifying diode and output filtering capacitor or by a voltage doubler detector fitted with two diodes and capacitors. A voltage amplifier, for instance a transistor, may possibly be provided at output of the detector if the field of the generator is insufficient to enable the production of a level at output of the detector enabling to control the power supply switching-controlled circuit.

FIG. 3 represents an example of a system containing such a simplified unit. The unit corresponds to the circuits of the block 10 or 10′ in the case of an additional CL bridge filter. The unit 10 includes an antenna 11 on a frequency selection CL circuit followed by a capacitor driving a voltage doubling rectifier/demodulator with two capacitors and diodes. The diodes are preferably HF diodes. In case where the sensitivity of the unit were too great, a resistive load or a resistive divider bridge may be added at output. The signal output detected in the unit goes high 1 when a signal sent by an adapted external frequency generator is detected.

The signal output detected in the unit is sent to a first input of an AND gate 25 which, when the Bluetooth® module 18 is not fed, receives a high signal 1 on its second input, the deactivation line 25′ of the module being low 0 and passing through an inverter 25″. When the module 18 is fed, the signal 25′ may go high, which blocks the output of the AND gate 25 go low 0 preventing any new activations by detection. The output of the gate and is sent to a first input of an OR gate 24 receiving by its second input a forcing line 24′ from the module 18 and intended, when on 1, to force the power supply of the module. The output of the OR gate 24 is sent to a time delay circuit composed of a diode, capacitor and (possibly) resistor enabling to hold on high 1 the gate voltage of a MOS transistor 22 for a set time once the output of the OR gate 24 has gone low 0. The MOS transistor 22 is installed as a switch (gate on 0)/conductor (gate on 1) of the power supply 16 entering the transistor 22 through the line 20 and sent back to the module 18 through the line 21. The module 18 includes an antenna 19 and inputs/outputs 9 towards notably a sensor or other. The module 18 being physically close to the unit 10, 10′, the deactivation line 25′ enables to prevent transmissions of the module 18 received and detected by the unit 10, 10′ from causing unwanted persistence of the power supply in the case of a simplified unit.

In this example of FIG. 3 one has implemented a deactivation line 25′ and a forcing line 24′ from the module 18. Both these lines are connected to the low potential 0 (ground) by resistors so that when the module 18 is not fed, their levels are equal to zero. However, to reduce the power consumption, the lines of the module or of other lines, as far as possible, should not be loaded (too much). In other embodiments, a single line may be used, which exhibits these double functions: the forcing blocks the detection. In case where the module 18 would require regulated voltage, a voltage regulator is interposed in the power supply line of the module, either on the line 20, or, preferably, on the line 21 or in common with the transistor 22, the regulator being then controlled.

Thus, it is preferable that the module 18 controls the holding sequence and the stoppage of the power supply once put in operation by a signal detected by the unit 10.

In more enhanced and active versions, the unit is a direct or heterodyne receiver. However, a unit is preferred, wherein a high frequency portion is reduced to the minimum possible and/or there are no high frequency oscillators. Indeed, in addition to the additional power consumption due to high frequency operation, shielding problems (radiofrequency compatibility) or stability problems may crop up. In the latter case, whereas the system may operate in extreme environmental conditions (temperature for instance) or with a time-varying voltage, notably at the expiry of the power supply source, too selective a reception unit may become inoperable whereas less selective a unit could have operated longer. Consequently, the unit should be selected according to the applications and to the endurance contemplated.

To guarantee correct operation of the system in the case where the module may control directly its power supply, one makes sure that in case of power cut of the module, the power supply control output remains stable (level corresponding to the power cut). In the reverse case, if the level of the power supply control output varies (goes back to a level corresponding to the power supply), the power supply of the module will be restored and the power supply of said module should practically never be cut. Preferably the 0 (zero voltage) should be selected as the level corresponding to the power cut and the level 1 (high voltage) for the power supply. With such a choice of levels, in case where the level of the power supply control output should vary during the power supply cut of the module, an integrating filter may be provided on the second command input of the power supply-controlled switching circuit to prevent the ingress of any high transients in case of power cut.

It should be understood that one of the purposes of the invention consisting in reducing the power consumption of the system when it is idle, one may, alternately to cutting the power supply of the module which is the solution preferred and described in detail, elect, instead of cutting the power supply and in case where the module may be placed in a low power consumption mode (sleep), to control the deactivation rather than cutting the power supply, whereas the power supply-controlled switching circuit instead of acting on the power supply of the module acting on the deactivation control input of the module. The latter solution advantageously dispenses with a power element in the power supply switching-controlled circuit, the intensity to be sent over on the deactivation control input of the module being extremely small.

1. A system for controlling a piece of equipment by electromagnetic radio waves, the system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments,
characterised in that the set temporal structure pattern is transmitted by an electromagnetic generator (6) according to the standard and external to the system and in that the reception and detection unit is a reception circuit, in the radio frequency band determined, and a circuit for detecting an amplitude modulation (ASK) with a detection output, the detector not being sensitive to the frequency and/or phase modulation, the level of the detection output toggling when the set temporal structure pattern is received and detected.

2. A system according to claim 1, characterised in that the standard is selected among the BLUETOOTH®, Wi-Fi® or GSM/GPRS® protocols and,
in the case of the BLUETOOTH® standard, the radio frequency band is the ISM band 2.4 GHz to 2.48 GHz, the function is an identification function and the data packet is an identity packet pattern (ID_packet),
and in the case of the GSM/GPRS® standard, the function is a handshake function and the data packet is a channel random access packet pattern (<<random access channel>> or RACH).

3. A system according to claim 2, characterised in that it is intended for switching the electric power supply of the equipment and that the detection output of the reception and detection unit is connected to a command input of a controlled circuit (15, 22) for switching the power supply of the equipment so that when the detection output toggles, the equipment is power supplied.

4. A system according to claim 3, characterised in that the equipment is a Bluetooth® communication module (18) containing a stand-alone power supply source (16), the communication module being power supply-controlled, the electromagnetic wave reception and detection unit (10) is according to the amplitude modulation (ASK) for detecting an identity packet (ID_Packet) of DAC or IAC type transmitted by the external electromagnetic generator (6) according to the BLUETOOTH® standard, the detection output of the reception and detection unit being connected to the command input of the power supply-controlled switching circuit so that, when the electromagnetic radio wave of the identification packet transmission function (ID_packet) is received and detected by the unit, the Bluetooth® communication module is powered by the stand-alone power supply source.

5. A system according to claim 1, characterised in that the reception and detection unit is a passive electronic tag (10), the power supply of the tag being provided by the electromagnetic generator, the electromagnetic waves of the electromagnetic generator being used for the power supply of the tag.

6. A system according to claim 1, characterised in that the reception and detection unit is an active electronic tag (10), the power supply of the tag being provided (17) by a stand-alone power supply source (16) of the equipment.

7. A system according to claim 3, characterised in that the power supply-controlled switching circuit includes moreover a time-delay means operatable by the command input and enabling to keep for a predetermined holding time the power supply of said equipment upon completed detection of the electromagnetic wave, the power supply of the equipment being switched off upon expiry of the predetermined holding time regardless whether there have been new detections or not during said holding time.

8. A system according to claim 3, characterised in that the power supply-controlled switching circuit includes moreover a time-delay means (23) operatable by the command input and enabling to keep for a predetermined initial holding time the power supply of said equipment upon completed detection of the electromagnetic wave, the power supply of the equipment being switched off upon expiry of the predetermined holding time failing any new detection during said holding time, the detection of the electromagnetic wave during the holding sequence extending the holding sequence during the detection and the holding sequence during the predetermined holding time at the expiry of the detection.

9. A system according to claim 7, characterised in that the equipment includes a power supply control output (24′) connected to a second command input of the power supply switching-controlled circuit, the equipment being thus capable of controlling directly its power supply once power-supplied further to the detection of electromagnetic waves.

10. A system according to claim 9, characterised in that it includes a watchdog for monitoring the power supply, the power supply-controlled switching circuit containing the time-delay means operatable by the command input with detection of the electromagnetic wave during the holding time extending the holding sequence for a new predetermined holding time, the time-delay means is moreover operatable by the second command input of the power supply switching-controlled circuit, said second input being active on a transition, whereby the equipment should regularly send said transitions via its power supply control output in order to maintain the power supply thereof.

11. A system according to claim 9, characterised in that the time-delay means operatable is replaced with a flip-flop logic with at least one function R/S and with
a set input (S),
an reset input (R),
the set input being connected to the output of the detector and the reset input being connected to a power supply control output.

12. An operating method of a system for controlling a piece of equipment by electromagnetic radio waves, the system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments,
characterised in that with a system according to any of the previous claims, the set temporal structure pattern is transmitted via an electromagnetic generator (6) according to the standard and external to the system and in that a command reception and detection unit is implemented which is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected.

13. A method according to claim 12, characterised in that a piece of equipment is implemented which is a Bluetooth® communication module (18) with stand-alone power supply source (16), and that the power supply of the module is controlled relative to the reception and detection of electromagnetic waves transmitted by the electromagnetic generator according to the BLUETOOTH® standard with a controlled circuit (15) for switching the power supply of said communication module (18) containing a command input, the detection output having been connected to the command input of the power supply-controlled switching circuit so that when the detection output toggles, the Bluetooth® communication module is power supplied, the external generator operating in the 2.4 GHz to 2.48 GHz ISM radio frequency band with a function which is an identification function and a data packet which is an identity packet pattern (ID_packet).

14. A radio communication assembly containing at least one system for controlling a piece of equipment by electromagnetic radio waves and at least one electromagnetic generator physically independent of the system, the system containing a command reception and detection unit independent of the equipment, the electromagnetic radio waves complying with a voice or data radio communication standard in a determined radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments,
characterised in that it includes a system according to claim 1, the command reception and detection unit being a reception circuit, in the determined radio frequency band, and being a detector for an amplitude modulation (ASK) with a detection output, the detector not being sensitive to the frequency and/or phase modulation, the level of the detection output toggling when the set temporal structure pattern is received and detected, and in that the temporal structure pattern is transmitted by an electromagnetic generator (6) according to the standard.

15. A radio communication assembly according to claim 14, characterised in that the electromagnetic wave reception and detection unit (10) is an electronic tag and in that the generator (10) is an electronic tag reader (6).

16. A radio communication assembly according to claim 15, characterised in that the equipment is a Bluetooth® communication module (18) containing a stand-alone power supply source (16), the communication module being power supply-controlled, the system being intended for switching the electric power supply of the communication module and the detection output of the tag being connected to a command input of a controlled circuit (15, 22) for switching the power supply of the communication module so that when the detection output toggles, the communication module is power supplied, and in that the electronic tag reader includes moreover a Bluetooth® radio communication device capable of making it communicate with a base station and the module (18) of the system.

17. A radio communication assembly according to claim 15, characterised in that the equipment is a Bluetooth® communication module (18) containing a stand-alone power supply source (16), the communication module being power supply-controlled, the system being intended for switching the electric power supply of the communication module and the detection output of the tag being connected to a command input of a controlled circuit (15, 22) for switching the power supply of the communication module so that when the detection output toggles, the communication module is power supplied, and in that the electromagnetic generator of the electronic tag reader operates in the 2.4 GHz to 2.48 GHz ISM radio frequency band with a function which is an identification function and a data packet which is an identity packet pattern (ID_packet).

18. An implementation method of the radio communication assembly of claim 16, characterised in that in:
a first step, the electronic tag reader (6) is actuated in order to generate electromagnetic waves enabling the reception and detection unit (10) to control the power supply of the Bluetooth® module (18) and feed said module (18),
a second step, at least one data exchange is conducted between the Bluetooth® module and the Bluetooth® radio communication device of the electronic tag reader,
a third step, the Bluetooth® module (18) controls the switching-off of its own power supply.

19. An electronic tag reader (6) for generating electromagnetic radio waves intended to operate a system containing a command reception and detection unit independent of the equipment, the electromagnetic radio waves complying with a voice or data radio communication standard in a determined radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments,
characterised in that the system complies with claim 1, that the reception and detection unit is a reception circuit, in the determined radio frequency band, and is a detector for an amplitude modulation (ASK) with a detection output, the detector not being sensitive to the frequency and/or phase modulation, the level of the detection output toggling when the set temporal structure pattern is received and detected, said reception and detection unit (10) being an electronic tag and the set temporal structure pattern being transmitted by the electromagnetic generator (6) of the tag reader according to the standard, the tag reader containing moreover a Bluetooth® radio communication device which may cause the reader (6) to communicate with a base station and the module (18) of the system.

20. An electronic tag reader (6) for generating electromagnetic radio waves intended to operate a system containing a command reception and detection unit independent of the equipment, the electromagnetic radio waves complying with a voice or data radio communication standard in a radio frequency band, the standard providing at least one function causing, in a transmitter according to the standard, the transmission of a data packet corresponding to a set temporal structure pattern containing transmission moments of a frequency and/or phase modulated radio-frequency signal separated by absence-of-transmission moments,
characterised in that the system complies with claim 1, the command reception and detection unit being a reception circuit, in the determined radio frequency band, and being a detector for an amplitude modulation (ASK) with a detection output, the detector not being sensitive to the frequency and/or phase modulation, the level of the detection output toggling when the set temporal structure pattern is received and detected, in that the reception and detection unit (10) is an electronic tag intended for receiving and detecting electromagnetic waves according to the BLUETOOTH® standard, and the electronic tag reader (6) includes an electromagnetic generator which is a radio communication device transmitting according to the BLUETOOTH® standard, the radio frequency band being the 2.4 GHz to 2.48 GHz ISM band, the function being an identification function and the data packet being an identity packet pattern (ID_packet).
